(19) United States
(12) Patent Application Publication
(10) Pub. No.: US 2025/0031883 A1
(43) Pub. Date: Jan. 30, 2025

(54) STRAIGHT EDGE FOOD AND BEVERAGE CONTAINER

(71) Applicants: Anna Compton, Bend, OR (US); Jerrod Compton, Bend, OR (US)

(72) Inventors: Anna Compton, Bend, OR (US); Jerrod Compton, Bend, OR (US)

(21) Appl. No.: 18/358,658

(22) Filed: Jul. 25, 2023

(51) Int. Cl. A47G 19/22; A47J 41/00

(52) U.S. Cl. CPC A47G 19/2288; A47G 19/2205; A47J 41/0072

(57) ABSTRACT

Examples of the present disclosure include a container having a receptacle configured to receive a beverage and a wall within which the receptacle is disposed. The wall includes a first end, a second end opposite to the first end, a base edge, and an outer surface extending along a length of the wall from the first end to the base edge. The base edge includes a base point. The outer surface includes a first point located a distance away from the edge point that is not less than 50% of a distance between the first end and the second end. The outer surface also includes a second point located a distance away from the edge point that is not greater than 10% of the distance between the first end and the second end. Each of the edge point, first point, and second point are collinear.

### FIELD

This disclosure relates generally to containers and more particularly to a straight edge beverage container.

### BACKGROUND

Containers, such as tumblers, can hold food or beverages and can be used to keep food or beverages hot or cold. Some containers are made of insulating materials and include a lid to prevent spills. Designs can be printed onto an outer wall of a container.

### SUMMARY

The subject matter of the present application has been developed in response to the present state of the art, and in particular, in response to the shortcomings of food and beverage containers, that have not yet been fully solved by currently available techniques. Accordingly, the subject matter of the present application has been developed to provide straight edge food and beverage containers that overcome at least some of the above-discussed shortcomings of prior art techniques.

Examples of the present disclosure include a container having a receptacle configured to receive at least one of a food or a beverage and a wall within which the receptacle is disposed. The wall includes a first end, a second end opposite to the first end, a base edge coplanar with the second end, and an outer surface extending along a length of the wall from the first end to the base edge. The base edge includes a base point. The outer surface includes a first point located a distance away from the edge point that is not less than 50% of a distance between the first end and the second end. The outer surface also includes a second point located a distance away from the edge point that is not greater than 10% of the distance between the first end and the second end. Each of the edge point, first point, and second point are collinear.

Examples of the present disclosure include a system. The system includes a container. The container includes a receptable configured to receive at least one of food or a beverage and a wall within which the receptable is disposed. The wall includes a first end, a second end opposite to the first end, and a base edge coplanar with the second end. The second end includes an edge point. The wall includes an outer surface extending along a length of the wall from the first end to the base edge. The outer surface includes a first point located a distance away from the edge point that is not less than 50% of a distance between the first end and the second end and a second point located a distance away from the edge point that is not greater than 10% of the distance between the first end and the second end. The container also includes a base located below the receptacle. The base converges with the base edge at a perimeter of the base and includes a groove. The system includes an insert configured to be partially and removably received by the groove of the base. The edge point, first point, and second point are collinear.

Examples of the present disclosure include a method of manufacturing a container. The method includes forming a container. The container includes a wall. The wall includes a first end, a second end opposite to the first end, a base edge coplanar with the second end, and an outer surface extending along a length of the wall from the first end to the base edge. The base edge includes a base point. The outer surface includes a first point located a distance away from the edge point that is not less than 50% of a distance between the first end and the second end. The outer surface also includes a second point located a distance away from the edge point that is not greater than 10% of the distance between the first end and the second end. Each of the edge point, first point, and second point are collinear. The method includes forming a receptacle configured to receive at least one of a food or a beverage within the container. The receptacle extends from the first end to a third point between the second end and the first end. The method includes coating the outer surface with a polymeric material and wrapping a sheet around the outer surface such that the sheet contacts the base edge and extends from the base edge to the first end. The method includes exposing the container to a heat source for an interval of time. The method includes removing the sheet from the outer surface.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a perspective view of an assembled container system, according to one or more examples of the present disclosure;

FIG. 1B is an exploded view of a container system, according to one or more examples of the present disclosure;

FIG. 1C is a front view of a container system, according to one or more examples of the present disclosure;

FIG. 1D is a close-up view of a container system, according to one or more examples of the present disclosure;

FIG. 1E is a bottom view of a container system with an insert removed, according to one or more examples of the present disclosure;

FIG. 1F is a bottom view of an assembled container system, according to one or more examples of the present disclosure;

FIG. 2 is a front view of a cylindrical container, according to one or more examples of the present disclosure;

FIG. 3A is a front view of a conical container, according to one or more examples of the present disclosure;

FIG. 3B is a close-up view of a container, according to one or more examples of the present disclosure;

FIG. 4 is an exploded view of a container system with a threaded inner surface and threaded lid, according to one or more examples of the present disclosure;

FIG. 5A is a side view of a container having a sheet attached thereto, according to one or more examples of the present disclosure;

FIG. 5B is a side view of a container having a printed design thereon, according to one or more examples of the present disclosure; and

FIG. 6 is a schematic flow chart of a method of manufacturing a container, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The following is a non-exhaustive list of examples, which may or may not be claimed, of the subject matter, disclosed herein.

The following portion of this paragraph delineates example 1 of the subject matter, disclosed herein. According to example 1, a container has a receptacle configured to receive at least one of a food or a beverage and a wall within which the receptacle is disposed. The wall includes a first end, a second end opposite to the first end, a base edge coplanar with the second end, and an outer surface extending along a length of the wall from the first end to the base edge. The base edge includes a base point. The outer surface includes a first point located a distance away from the edge point that is not less than 50% of a distance between the first end and the second end. The outer surface also includes a second point located a distance away from the edge point that is not greater than 10% of the distance between the first end and the second end. Each of the edge point, first point, and second point are collinear.

The following portion of this paragraph delineates example 2 of the subject matter, disclosed herein. According to example 2, which encompasses example 1, above, a container includes a base converging with the base edge at a perimeter of the base, the base comprising a groove.

The following portion of this paragraph delineates example 3 of the subject matter, disclosed herein. According to example 3, which encompasses example 1 or 2, above, the wall is substantially cylindrical in shape and comprises an open side opposite to the base.

The following portion of this paragraph delineates example 4 of the subject matter, disclosed herein. According to example 4, which encompasses any one of examples 1-3, above, the wall has a uniform perimeter along a length of the wall.

The following portion of this paragraph delineates example 5 of the subject matter, disclosed herein. According to example 5, which encompasses any one of examples 1-2, above, a perimeter of the wall at the first end is greater than or equal to the perimeter of the base.

The following portion of this paragraph delineates example 6 of the subject matter, disclosed herein. According to example 6, which encompasses any of examples 1-5, above, the container includes an inner surface disposed within the wall and defining the receptacle. The inner surface includes a threaded portion.

The following portion of this paragraph delineates example 7 of the subject matter, disclosed herein. According to example 7, which encompasses any of examples 1-6, the edge point includes a point located to contact a surface when the container rests directly on the surface.

The following portion of this paragraph delineates example 8 of the subject matter, disclosed herein. According to example 8, which encompasses any of examples 1-7, the wall is straight along the length of the wall.

The following portion of this paragraph delineates example 9 of the subject matter, disclosed herein. According to example 9, which encompasses any of examples 1-8, a length of the wall from the first end to the second end is not less than 4 inches and not greater than 15 inches.

The following portion of this paragraph delineates example 10 of subject matter, disclosed herein. According to example 10, a system includes a container. The container includes a receptable configured to receive at least one of food or a beverage and a wall within which the receptable is disposed. The wall includes a first end, a second end opposite to the first end, and a base edge coplanar with the second end. The second end includes an edge point. The wall includes an outer surface extending along a length of the wall from the first end to the base edge. The outer surface includes a first point located a distance away from the edge point that is not less than 50% of a distance between the first end and the second end and a second point located a distance away from the edge point that is not greater than 10% of the distance between the first end and the second end. The container also includes a base located below the receptacle. The base converges with the base edge at a perimeter of the base and includes a groove. The system includes an insert configured to be partially and removably received by the groove of the base. The edge point, first point, and second point are collinear.

The following portion of this paragraph delineates example 11 of the subject matter, disclosed herein. According to example 11, which encompasses example 10, the insert has a height that is greater than a depth of the groove.

The following portion of this paragraph delineates example 12 of the subject matter, disclosed herein. According to example 12, which encompasses any of examples 10-11, the container includes an insulating, stainless steel material.

The following portion of this paragraph delineates example 13 of the subject matter, disclosed herein. According to example 13, which encompasses any of examples 10-12, the outer surface is coated with a powder material.

The following portion of this paragraph delineates example 14 of the subject matter, disclosed herein. According to example 14, which encompasses any of examples 10-13, the base edge is concentric with the groove.

The following portion of this paragraph delineates example 15 of the subject matter, disclosed herein. According to example 15, which encompasses any of examples 10-14, the insert is made of a silicon material.

The following portion of this paragraph delineates example 16 of the subject matter, disclosed herein. According to example 16, which encompasses any of examples 10-15, each of the groove and a perimeter of the insert are substantially circular in shape.

The following portion of this paragraph delineates example 17 of the subject matter, disclosed herein. According to example 17, which encompasses any of examples 10-16, the insert is configured to contact a surface and elevate the container from the surface while the insert is received by the groove.

The following portion of this paragraph delineates example 18 of the subject matter, disclosed herein. According to example 18, which encompasses any of examples 10-17, the system includes an inner surface disposed within the wall and defining the receptacle. The inner surface has a threaded portion. The system includes a lid. The lid has a threaded portion configured to mate with the threaded portion of the inner surface.

The following portion of this paragraph delineates example 19 of subject matter, disclosed herein. According to example 19, a method includes forming a container. The container includes a wall. The wall includes a first end, a second end opposite to the first end, a base edge coplanar with the second end, and an outer surface extending along a length of the wall from the first end to the base edge. The base edge includes a base point. The outer surface includes a first point located a distance away from the edge point that is not less than 50% of a distance between the first end and the second end. The outer surface also includes a second point located a distance away from the edge point that is not greater than 10% of the distance between the first end and the second end. Each of the edge point, first point, and second point are collinear. The method includes forming a receptacle configured to receive at least one of a food or a beverage within the container. The receptacle extends from the first end to a third point between the second end and the first end. The method includes coating the outer surface with a polymeric material and wrapping a sheet around the outer surface such that the sheet contacts the base edge and extends from the base edge to the first end. The method includes exposing the container to a heat source for an interval of time. The method includes removing the sheet from the outer surface.

The following portion of this paragraph delineates example 20, disclosed herein. According to example 20, which includes example 19 disclosed above, the sheet includes sublimation paper having dyed ink thereon. The interval of time is sufficient to transfer at least a portion of the dyed ink onto the outer surface.

Examples of the present disclosure include containers that are configured to hold food and beverages. For example, a container includes a tumbler configured to hold a beverage and to allow the user to drink the beverage therefrom. In some examples, such containers are made of insulating materials, such as stainless steel. Direct contact between a base of a container and surfaces (e.g., a work surface such as a desk or a table), particularly containers made of such materials, can cause unwanted noise, sliding, and/or erosion of the base. As such, examples of the present disclosure help to reduce noise, sliding, and erosion that typically result from contact between a surface and a base of a container resting on that surface. Additionally, printing designs onto an outer surface of the container allows for increased aesthetic appeal and customization. Examples of the present disclosure include containers with walls that are substantially straight at the ends. As such, examples of the present disclosure help to achieve a more complete transfer of ink onto an outer surface of a container by allowing the ink to be transferred to the entire surface area of the outer wall of the container and reducing gaps in the design at the ends of the container.

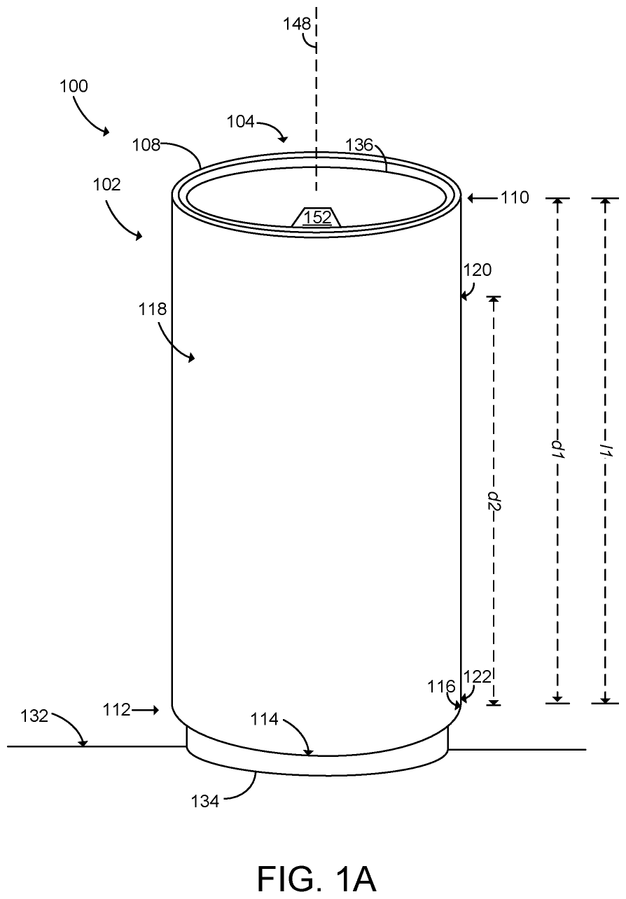

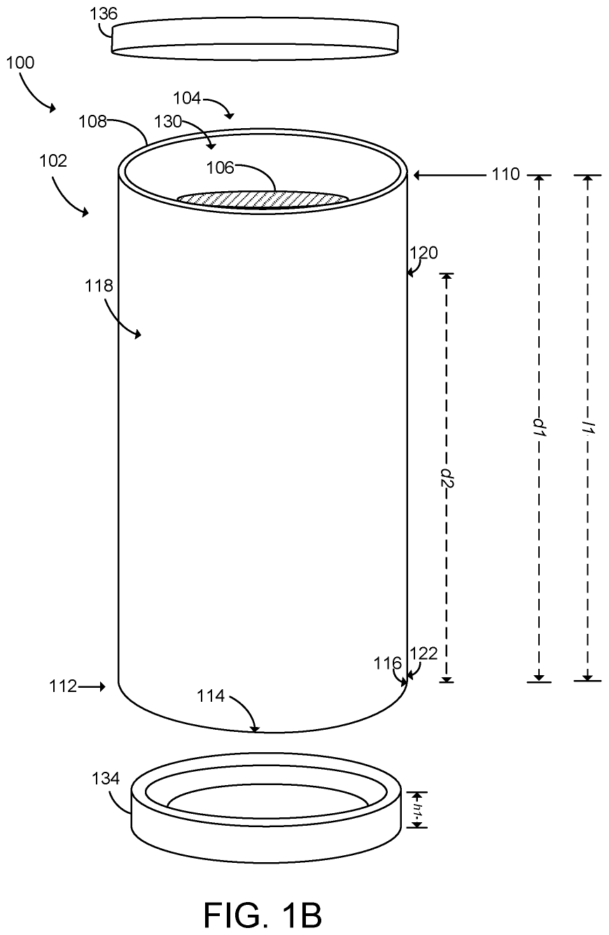

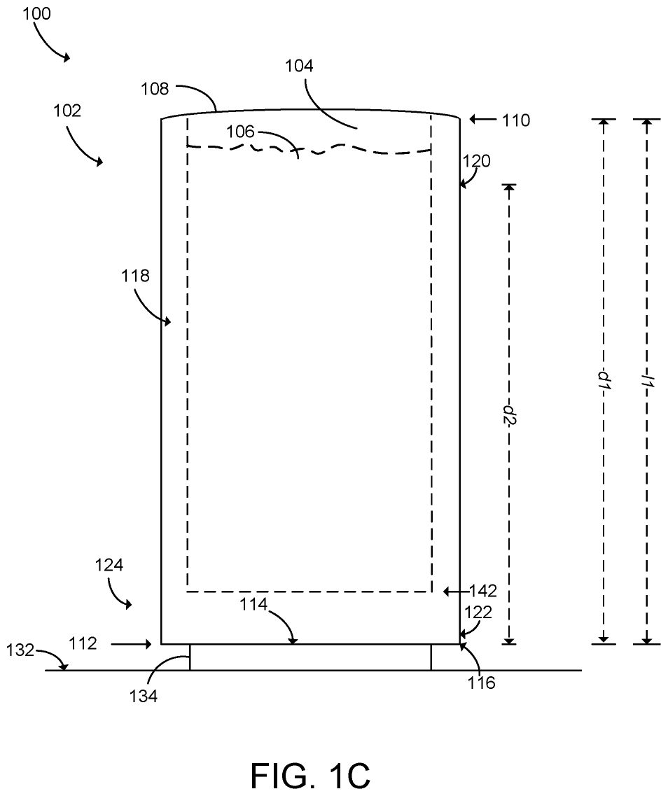

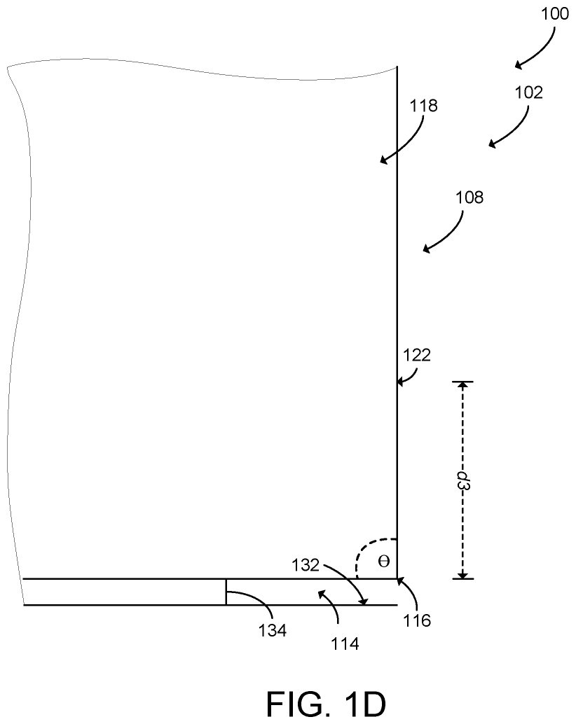

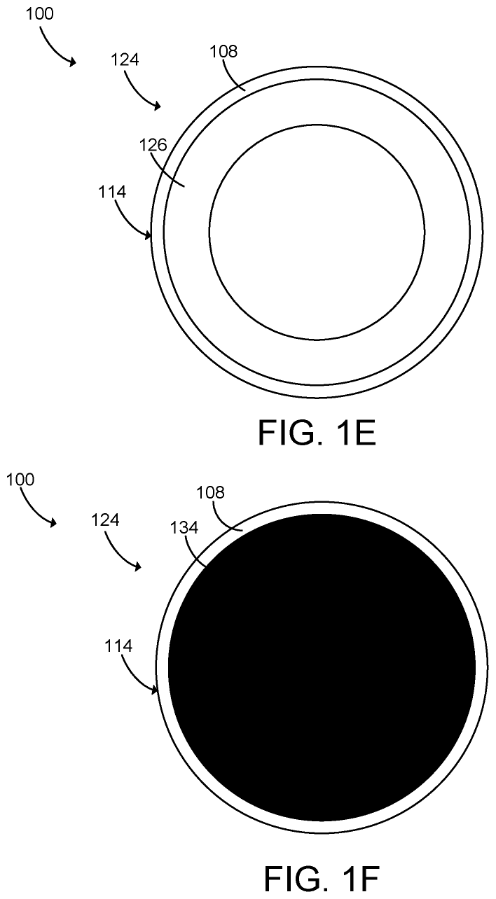

FIG. 1A is a perspective view of an assembled container system 100, according to one or more examples of the present disclosure. FIG. 1B is an exploded view of the container system 100 of FIG. 1A, according to one or more examples of the present disclosure. As shown in FIG. 1A, the container system 100 includes a container 102 and an insert 134. In some examples, the container system 100 also includes a removable lid 136. As shown in FIGS. 1A-B, container 102 includes an outer wall 108 extending along a length l1 from a base edge 114 at one end 112 of the container to another end 110.

As shown in FIG. 1B, with a lid 136 removed, the container 102 includes an open top 128 at the first end 110, opposite to the base edge 114. The container 102 includes a receptacle 104 configured to receive at least one of a food or beverage 106 through the open top 128. In some examples, a food or a beverage is received through the open top 128 when the lid 136 is removed. The lid 136 includes an opening 152 through which the user can consume the food or beverage 106 while the lid 136 is attached to the container 102. For example, the receptacle 104 receives a beverage 106 to be consumed by the user from the container 102. In some examples, the beverage 106 is a cold beverage, such as cold water or iced coffee. In other examples, the beverage is a hot beverage, such as hot coffee, hot tea, hot chocolate, or hot broth. In some examples, the container 102 is made of an insulating material, such as ceramic or stainless steel, to maintain the temperature of the beverage.

The container 102 includes a wall 108 within which the receptacle 104 is disposed. For example, the wall 108 is an outer wall of the container 102. Although not shown in FIGS. 1A-B, in some examples, the container 102 is a double-walled container and includes an inner wall between the receptacle 104 and the wall 108, with insulating material between the inner wall and the wall 108.

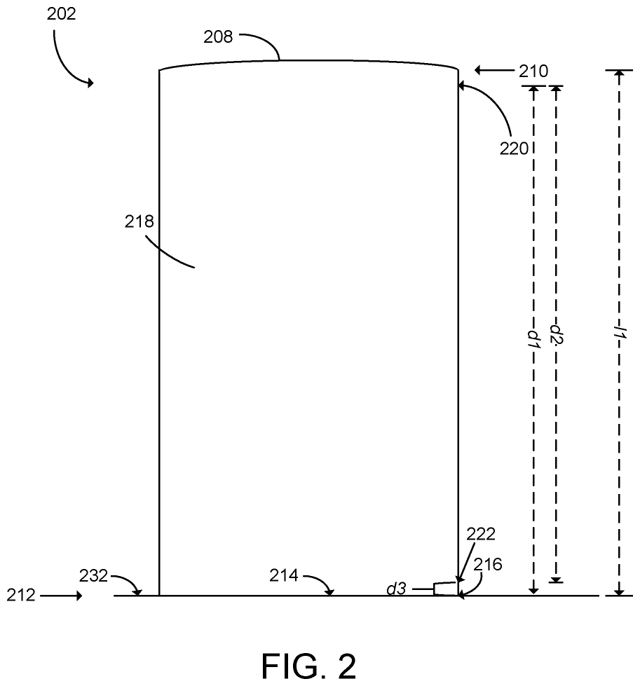

The wall 108 includes a first end 110 and a second end 112 opposite to the first end 110. In some examples, the first end 110 is an end 110 of the wall 108 positioned at or near the top of the container 102 when the container 102 rests on a surface 132. In some examples, as shown in FIGS. 2-4, the second end 112 contacts the surface 132 when the container 102 rests on the surface 132. As shown in FIG. 1A, in some examples, the first end 110 is in closer proximity to the lid 136 than the second end 112 is.

The wall 108 includes a base edge 114 coplanar with the second end 112. For the example, the base edge 114 and the second end 112 both lie in a plane substantially parallel to the surface 132 on which the container 102 rests. In some examples, the base edge 114 and the second end 112 both lie in the same plane substantially perpendicular to a center line 148 of the container 102. In some examples, the base edge 114 is defined by the perimeter of the container 102 at the second end 112. For example, as shown in FIGS. 1E and 1F, the base edge 114 is substantially circular.

The base edge 114 includes a plurality of points along a perimeter of the container 102, including an edge point 116. As shown in FIG. 2, in some examples in which the insert 134 is removed from the base 124, the edge point 116 contacts the surface 132 on which the container 202 rests.

The wall 108 includes an outer surface 118 extending along a length l1 of the wall 108 from the first end 110 to the base edge 114. The outer surface 118 includes a first point 120. The first point 120 is located a distance d2 away from the edge point 116 that is not less than 50% of the distance d1 between the first end 110 and the second end 112. In some examples, the first point 120 is located on an upper half of the container 102. In some examples, the first point 120 is located at or near the first end 110 of the container 102.

The outer surface 118 includes a second point 122. The second point 122 is located a distance d3 away from the edge point 116 that is not less than 10% of the distance d1 between the first end 110 and the second end 112. In some examples, the distance d3 is less than one centimeter (“cm”). In some examples, the outer surface 118 does not include any curvature between the edge point 116 and the second point 122.

In some examples, each of the edge point 116, first point 120, and second point 122 are colinear. In some examples, the wall 108 has a substantially straight edge from the edge point 116, along the length l1 of the outer surface 118, and up to the first end. In other words, each point along the outer surface 118 is positioned on an imaginary line from the first end 110 to the second end 112, and each point along the imaginary line is positioned on the outer surface 118. A substantially straight line could be drawn from the surface 132 on which the container rests 102 up to a top edge 110 of the container 102. In some examples, the edge point 116 is a bottom-most point along the outer surface 118. In some examples, the edge point 116 is colinear with the first point 120 and a number of additional points along the outer surface 118 that are located between the edge point 116 and evenly spaced between the edge point 116 and the first point 120. For example, the first point 120 is positioned at the top end 110 of the wall 108, and the edge point 116 is collinear with the first point 120 and with a number of additional points along the outer surface 118.

In some examples, an imaginary line that includes both the edge point 116 and a top end 110 of the container 102 runs along the outer surface 118 and is completely external to the container 102. In some examples, an imaginary line lying in a plane substantially perpendicular to the plane of the base edge 114 and substantially parallel to the center line 148 is tangential to the outer surface 118 and extends from the edge point 116 to the first end 110. In other words, as shown in FIG. 1D, in some examples, a bottom half of the outer surface 118 extends in a straight line from the edge point 116 to a midpoint of the container 102.

As shown in FIG. 1B, in some examples, the wall 108 is substantially cylindrical in shape. In some examples, the wall 108 has a perimeter that is substantially uniform along the length l1 of the wall. In such examples, the outer surface 118 extends along a length l1 from the edge point 116 to the first point 120 in a direction that is parallel to the center line 148. An imaginary line along the outer surface 118 and parallel to the center line 148 includes the edge point 116, the first point 120, and the second point 122.

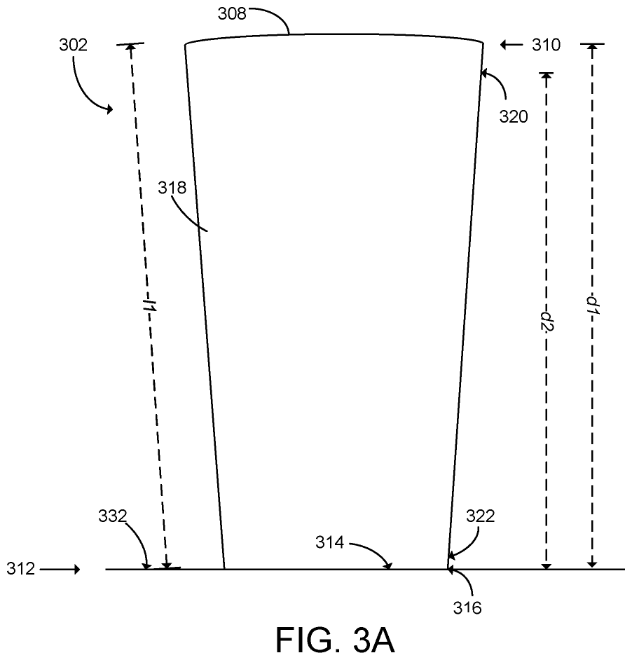

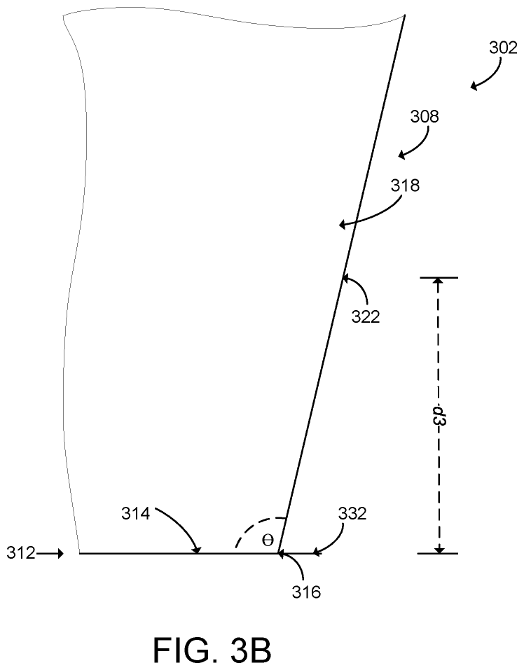

As shown in FIGS. 1A-B, in some examples, the length l1 of the wall 108 is approximately equal to the distance d1 between the first end 110 and the second end 112. However, examples of the present disclosure are not so limited. As shown in FIG. 3A, examples of the present disclosure include a conical-shaped container 302. In such examples, the height d1 of the container 302 is less than the length l1 of the wall 108. In such examples, the perimeter of the wall 108 at the first end 310 is greater than the perimeter of the wall 308 along the base edge 314. In some examples, as shown in FIGS. 1A-B, the perimeter of the wall 108 at the first end 110 is equal to the perimeter of the wall 108 along the base edge 114, or the perimeter of the base 124.

In some examples, the container 102 is configured to hold no less than 10 and no greater than 50 fluid ounces of a beverage 106 within the receptacle 104. In other words, the total volume of the receptacle 104 is not less than 10 fluid ounces and not greater than 50 fluid ounces. In some examples, the length l1 of the wall 108 is not less than 4 inches and not greater than 15 inches.

In some examples, the container 102 includes an insulating material. For example, the container 102 includes a stainless steel material, such as stainless steel 304. However, examples of the present disclosure are not so limited. In some examples, the container 102 is made of one or more materials including, but not limited to, glass, plastic, ceramic, bamboo, wood, metal, silicone, foam, or any combination thereof.

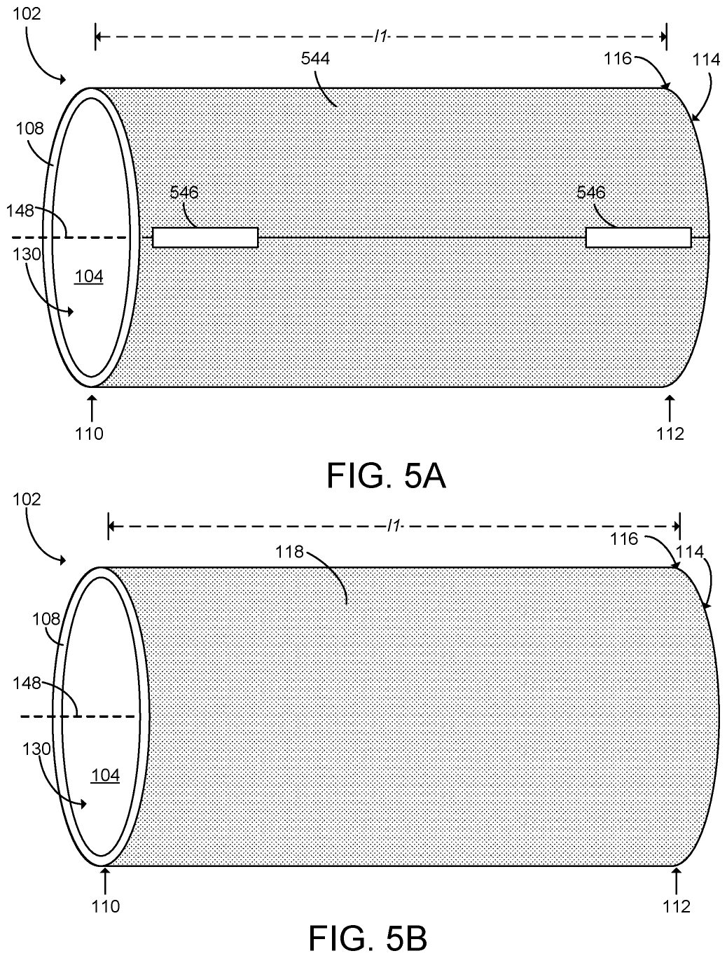

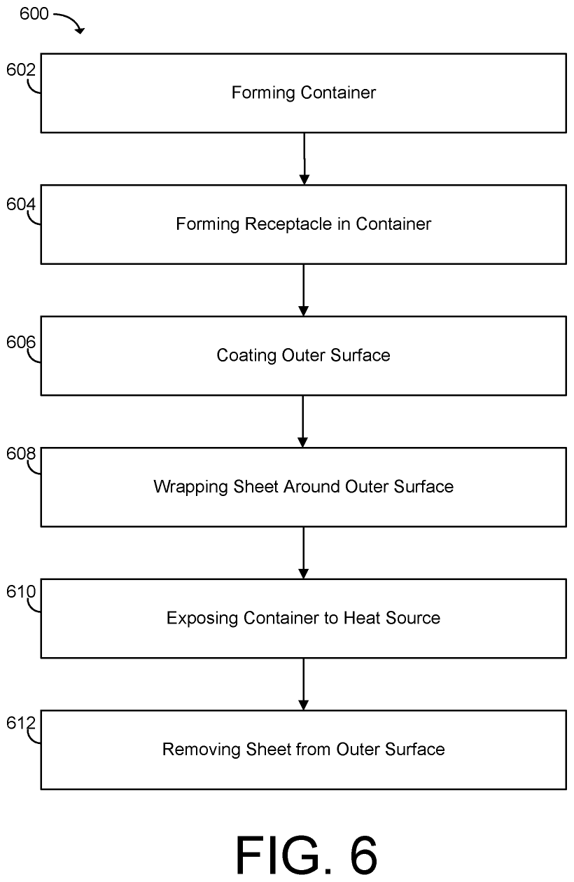

In some examples, the outer surface 118 includes a sublimation coating that allows a design to be printed thereon, as shown in FIG. 5B and described in connection with FIGS. 5A-6. In some examples, the outer surface 118 is also coated with a powder material. The powder material includes, for example, polyester, epoxy, fluoropolymer, polyurethane, resins, curatives, or any combination thereof. For example, the container 102 is made of stainless steel and is coated with both a sublimation coating and a powder coating.

FIG. 1C is a front view of the container system 100 of FIGS. 1A-1B, according to one or more examples of the present disclosure. The view shown in FIG. 1C is positioned at substantially eye level with the base edge 114 of the container 102. As shown in FIG. 1C, in some examples, the wall 108 is straight along the length l1 of the wall 108.

FIG. 1D is a close-up view of a container system 100, according to one or more examples of the present disclosure. As shown in FIG. 1D, the edge 118 of the outer surface extends in a substantially straight line from the base edge point 116 to the second point 122. In some examples, the wall 108 does not have any curvature. In some examples, the angle Θ between the base edge 114 and the wall 108 is uniform along the length l1 of the wall 108, even between the edge point 116 and the second point 122. In other examples, the angle Θ varies by no more than one degree along the length l1 of the wall 108. In some examples, the angle Θ is not less than 88 and not greater than 92 degrees. FIG. 1D illustrates an inner wall 154. The inner wall 154 and the bottom end 142 define the receptacle 104. As shown in FIG. 1D, in some examples, the inner wall 154 is substantially perpendicular to a bottom end 142 of the receptacle 104. In other examples, unlike the wall 108 and the outer surface 118, at least one portion of the inner wall 154 and/or the bottom end 142 is curved.

FIG. 1E is a bottom view of a container system 100 with an insert 134 removed, according to one or more examples of the present disclosure. As shown in FIG. 1E, the container 102 includes a base 124 converging with the base edge 114 at a perimeter of the base 124. As shown in FIG. 1E, in some examples, the base edge 114 is an enclosed shape, and the base 124 includes the portions of the container 102 located within the enclosed shape of the base edge 114 and extending up to the third point 142 from the second end 112 of the container 102. In some examples, the base 124 includes the second end 112 of the container 102.

As shown in FIG. 1E, the base 124 includes a groove 126. In some examples, the groove 126 is shaped similarly to the shape of the base edge 114. For example, as shown in FIG. 1E, the groove 126 is substantially circular. As shown in FIG. 1E, in some examples, the base edge 114 is concentric with the groove 126. Although not shown in FIG. 1E, in some examples, the base includes a protrusion, and the insert includes a groove configured to mate with the protrusion.

FIG. 1F is a bottom view of an assembled container system 100, according to one or more examples of the present disclosure. As shown in FIG. 1F, the system 100 includes an insert 134 configured to be partially and removably received by the groove 126 of the base 124. As such, as shown in FIGS. 1A and 1C, the insert 134 is configured to contact a surface 132 on which the system 100 is resting and elevate the container 102 with the surface 132 while the insert 134 is received by the groove 126.

Additionally or alternatively, in some examples, the insert 134 is received by an additional groove in the base 124 and/or another indentation in the base 124. For example, the base 124 includes an indentation that is concentric with the groove 126. In such examples, the insert 134 includes a protrusion shaped to be received by the indentation in addition to and/or as an alternative to the rim of the insert 134 being received by the groove 126.

As shown in FIG. 1B, in some examples, the height h1 of the insert 134 is greater than a depth of the groove 126. For example, the height h1 of the insert 134 is not less than 3 millimeters (“mm”) and not greater than 5 mm. In some examples, the difference between the height h1 of the insert 134 is greater than zero but not greater than one inch. For example, the groove 126 has a depth of 3 mm, and the height h1 of the insert 134 is 4 mm. In some examples, the insert 134 is rounded and/or slightly curved at the bottom. For example, unlike the container 102, the insert 134 has slightly curved edges. In some examples, the groove 126 receives a rim 154 of the insert 134. The rim 154 has a width sufficiently small to fit within the groove 126 but sufficiently large to create a friction fit between the insert 134 and the container 102. In some examples, each section of the groove 126 along the perimeter of the groove has a width of not less than 2 mm and not greater than 15 mm.

In some examples, the insert 134 is made of a silicon material. However, examples of the present disclosure are not so limited. In some examples, the insert 134 is made of a non-metallic material, such as rubber, plastic, foam, paper, or any combination thereof. In some examples, the insert 134 is made of a non-insulating material, and the container 102 is made of an insulating material.

In some examples, the insert 134 is not removable from the container 102 but is fixedly attached to the container 102. For example, an adhesive holds the insert 134 within the groove 126.

As shown in FIGS. 1E-F, in some examples, each of the groove 126 and the base edge 114 are substantially circular in shape. As used herein, “substantially circular” includes circular shapes and ellipse shapes.

FIG. 2 is a front view of a container 202 without an insert 134, according to one or more examples of the present disclosure. As shown in FIG. 2, in some examples, the container 202 includes an edge point 216. The edge point 216 is a point located on the base edge 214 and rests directly on a surface 232 on which the container 202 rests. Each point along the base edge 214 rests directly on a surface 232 on which the container 202 rests. For example, the container 202 is placed on a table having a surface 232, and the base edge 214 contacts the surface 232 of the table.

FIG. 3A is a front view of a conical container 302, according to one or more examples of the present disclosure. The container 302 is an example of the container 102 described in connection with FIGS. 1A-1B. As shown in FIG. 3A, in some examples, a perimeter of the container 302 varies along a length l1 of the wall 308. For example, the minimum perimeter of the container 302 is the perimeter of the base edge 316, which is less than a perimeter of the container 302 at the top end 310. In such examples, the perimeter of the container 302 increases at a uniform rate from the second end 312 to the first end 310.

FIG. 3B is a close-up view of the container 302 of FIG. 3A, according to one or more examples of the present disclosure. As shown in FIG. 3B, in some examples, the angle Θ between the wall 308 and the base edge 314 is greater than 90 degrees. For example, the angle Θ is greater than 90 degrees and not greater than 120 degrees. Even in such examples, the edge point 316, first point 320, and second point 322 are collinear, as described in connection with FIGS. 1A-E.

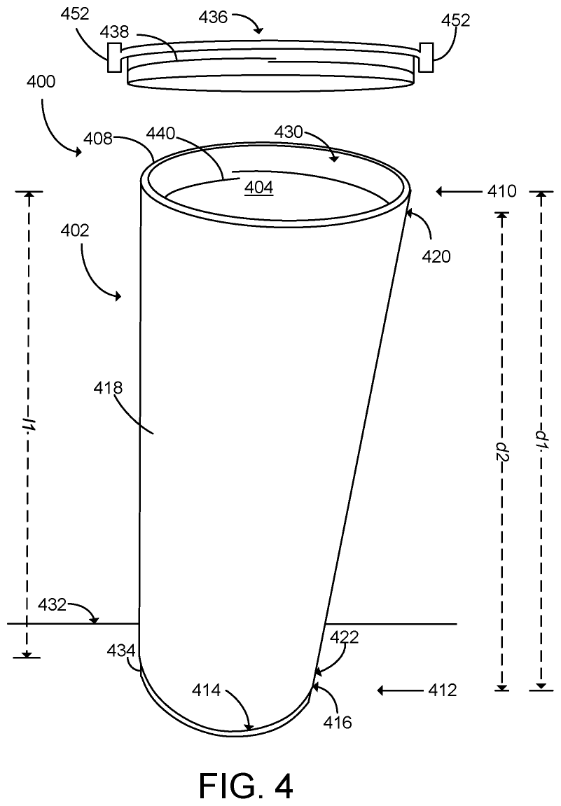

FIG. 4 is an exploded view of a container system 400 with a threaded inner surface 430 and threaded lid 436, according to one or more examples of the present disclosure. The container system 400 includes a container 402, an insert 434, and a removable lid 436. The container 402 is an example of the containers 102, 202, and 302.

As shown in FIG. 4, in some examples, the container 402 includes an inner surface 430 disposed within the wall 408 of the container 402 and defining the receptacle 404. In some examples, the inner surface 430 includes one or more threaded portions 440. In other words, the inner surface 430 includes one or more grooves and/or protrusions. As shown in FIG. 4, the system 400 includes a lid 436 configured to cover an open top 428 of the container 402. As shown in FIG. 4, in some examples, the lid 436 includes a number of threaded portions 438 configured to mate with the threaded portions 440 of the inner surface 430.

As shown in FIG. 4, in some examples, the lid 436 includes a number of tabs 456. In some examples, the tabs 456 are configured to help secure the lid 436 to the container 402. In some examples, the tabs 456 are made of a flexible material and are configured to fit around the wall 408 of the container 402.

FIG. 5A is a side view of a container 102 having a sheet 544 attached thereto, according to one or more examples of the present disclosure. Although FIGS. 5A-B show container 102, examples of the present disclosure also include performing the process described in connection with FIGS. 5A-6 with any of the containers 102, 202, 302, and/or 402 described herein. As shown in FIG. 5A, in some examples, customizing the outer surface 118 of a container 102 includes transferring a design from a sheet 544 to the outer surface 118. In some examples, the shape of the container 102 allows the sheet 544 to contact the container 102 all along the outer surface 118, from the first end 110 to the second end 112, without needing to bend the sheet 544. Specifically, the lack of curvature between the second point 122 and the edge point 116 allows the design to be transferred to the outer surface 118 in the area between the second point and the edge point 116 without a need to bend the sheet 544.

In some examples, the sheet 544 is a sublimation paper. For example, the sheet 544 is made of a paper substrate and includes a coating of a conductive material. For example, the sheet 544 is coated with silica. In some examples, a binder material, such as a polymer, binds the coating to the paper substrate of the sheet 544.

In some examples, the sheet 544 completely covers the outer surface 118. In some examples, the sheet 544 is temporarily secured around the outer surface 118 via one or more attachment mechanisms 546. The attachment mechanisms include 546, for example, adhesives, tape, glue, or any combination thereof.

FIG. 5B is a side view of a container 102 having a printed design along a length l1 of the outer surface 118, according to one or more examples of the present disclosure. As shown in FIG. 5B, after the design of the sheet 544 is cured to the outer surface 118, the sheet 544 is removed, and the design of the sheet 544 is permanently printed onto the outer surface 118 of the container 102. As shown in FIG. 5B, the design is cured to the outer surface 118, even in the area of the outer surface 118 between the second point 122 and the edge point 116.

FIG. 6 is a schematic flow chart of a method 600 of manufacturing a container, according to one or more examples of the present disclosure. As shown in FIG. 6, the method 600 includes forming 602 a container (e.g., containers 102, 202, 302, 402, or 502). The container 102 includes a wall 108 that includes a first end 110 and a second end 112 opposite to the first end 110. The wall 108 also includes a base edge 114 coplanar with the second end 112. The base edge 114 includes an edge point 116. The wall 108 includes an outer surface 118 extending along a length of the wall 108 from the first end 110 to the base edge 114. The outer surface 118 includes a first point 120 located a distance d2 away from the edge point 116 that is not less than 50% of a distance between the first end 110 and the second end 112. The outer surface 118 also includes a second point 122 located a distance d3 away from the edge point 116 that is not greater than 10% of the distance d1 between the second end 112 and the first end 110. Each of the edge point 116, first point 120, and second point 122 are colinear.

The method 600 includes forming 604 a receptacle 104 within the container 102. The receptacle 104 is configured to receive at least one of a food or a beverage 106 and extends from the first end 110 to a third point 142 between the second end 112 and the first end 110.

The method 600 includes coating 606 the outer surface 118 with a polymeric material. For example, the method 600 includes coating the outer surface 118 with a sublimation coating. In some examples, the method 600 also includes coating the outer surface 118 with a layer of powder (e.g., powdered polymer) in addition to the first layer of polymeric material.

The method 600 includes wrapping 608 a sheet 544 around the outer surface 118 such that the sheet 544 contacts the base edge 114 and extends from the base edge 114 to the first end 110, as shown in FIG. 5A, for example. In some examples, the method 600 also includes attaching the sheet 544 to the container 102. For example, one or more attachment mechanisms 546 secure the sheet 544 to the container by attaching two ends of the sheet 544 together. In other examples, the attachment mechanisms 546 attach the sheet 544 to the container 102 via the inner surface 130 and/or the base 124 of the container 102.

In some examples, the sheet 544 includes sublimation paper having dyed ink thereon. In some examples, the sheet 544 also includes a conductive layer that allows the dyed ink to be transferred from the sheet 544 to another surface upon exposure to heat.

The method 600 includes exposing 610 the container 102 to a heat source for an interval of time, with the sheet 544 wrapped around the container 102. Exposing the container 102 to the heat source is also referred to herein as “curing.” In some examples, the interval of time is sufficient to transfer at least a portion of the dyed ink onto the wall 508. For example, the method 600 includes inserting the container 102 into a press. In another example, the method 600 includes inserting the container 102 into an oven. In some examples, the interval of time is no less than 15 seconds and no greater than 200 seconds. In some examples, the heat is air at a temperature of no less than 350 degrees fahrenheit and no greater than 450 degrees fahrenheit. In some examples, the interval of time is proportional to the temperature. In some examples, the interval of time is also proportional to the area of the outer surface 118.

The method 600 includes removing 612 the sheet 544 from the wall 108, as shown in FIG. 5B. For example, the method 600 includes detaching the attachment mechanisms 546 and pulling the sheet 544 away from the wall 108.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A container, comprising:
a receptable configured to receive at least one of food or a beverage; and
a wall within which the receptable is disposed, the wall comprising:
a first end;
a second end opposite to the first end;
a base edge coplanar with the second end and comprising an edge point; and
an outer surface extending along a length of the wall from the first end to the base edge, the outer surface comprising:
a first point located a distance away from the edge point that is not less than 50% of a distance between the first end and the second end; and
a second point located a distance away from the edge point that is not greater than 10% of the distance between the first end and the second end,
wherein each of the edge point, first point, and second point are collinear.

2. The container of claim 1, further comprising a base converging with the base edge at a perimeter of the base, the base comprising a groove.

3. The container of claim 2, wherein the wall is substantially cylindrical in shape and comprises an open side opposite to the base.

4. The container of claim 3, the wall having a uniform perimeter along a length of the wall.

5. The container of claim 2, wherein a perimeter of the wall at the first end is greater than or equal to the perimeter of the base.

6. The container of claim 1, further comprising an inner surface disposed within the wall and defining the receptacle, the inner surface comprising a threaded portion.

7. The container of claim 1, wherein the edge point comprises a point located to contact a surface when the container rests directly on the surface.

8. The container of claim 1, wherein the wall is straight along the length of the wall.

9. The container of claim 1, wherein a length of the wall from the first end to the second end is not less than 4 inches and not greater than 15 inches.

10. A system, comprising:
a container, comprising:
a receptable configured to receive at least one of food or a beverage; and
a wall within which the receptable is disposed, the wall comprising:
a first end;
a second end opposite to the first end;
a base edge coplanar with the second end and comprising an edge point;
an outer surface extending along a length of the wall from the first end to the base edge, the outer surface comprising:
a first point located a distance away from the edge point that is not less than 50% of a distance between the first end and the second end; and
a second point located a distance away from the edge point that is not greater than 10% of the distance between the first end and the second end; and
a base located below the receptable, converging with the base edge at a perimeter of the base, and comprising a groove; and
an insert configured to be partially and removably received by the groove of the base,
wherein each of the edge point, first point, and second point are collinear.

11. The system of claim 10, the insert having a height that is greater than a depth of the groove.

12. The system of claim 10, wherein the container comprises an insulating, stainless-steel material.

13. The system of claim 10, wherein the outer surface is coated with a powder material.

14. The system of claim 10, wherein the base edge is concentric with the groove.

15. The system of claim 10, wherein the insert is made of a silicon material.

16. The system of claim 10, wherein each of the groove and a perimeter of the insert are substantially circular in shape.

17. The system of claim 10, wherein the insert is configured to contact a surface and elevate the container from the surface while the insert is received by the groove.

18. The system of claim 10, further comprising:
an inner surface disposed within the wall and defining the receptacle, the inner surface comprising a threaded portion; and
a lid comprising a threaded portion configured to mate with the threaded portion of the inner surface.

19. A method of manufacturing a container, comprising:
forming a container, the container comprising a wall comprising:
a first end;
a second end opposite to the first end;
a base edge coplanar with the second end and comprising an edge point;
an outer surface extending along a length of the wall from the first end to the base edge, the outer surface comprising:
a first point located a distance away from the edge point that is not less than 50% of a distance between the first end and the second end; and
a second point located a distance away from the edge point that is not greater than 10% of the distance between the first end and the second end,
wherein each of the edge point, first point, and second point are collinear;
forming a receptacle configured to receive at least one of food or a beverage within the container, the receptacle extending from the first end to a third point between the second end and the first end;
coating the outer surface with a polymeric material;
wrapping a sheet around the outer surface such that the sheet contacts the base edge and extends from the base edge to the first end;
exposing the container to a heat source for an interval of time; and
removing the sheet from the outer surface.

20. The method of claim 19, wherein:
the sheet comprises sublimation paper having dyed ink thereon; and
the interval of time is sufficient to transfer at least a portion of the dyed ink onto the outer surface.
